(19) United States
(12) Patent Application Publication
(10) Pub. No.: US 2020/0220400 A1
(43) Pub. Date: Jul. 9, 2020

(54) INTERIOR PERMANENT MAGNET ELECTRIC MACHINE WITH TAPERED BRIDGE STRUCTURE

(71) Applicant: BorgWarner Inc., Auburn Hills, MI (US)

(72) Inventor: Seong Taek Lee, Noblesville, IN (US)

(21) Appl. No.: 16/242,340

(22) Filed: Jan. 8, 2019

(51) Int. Cl. H02K 1/27

(52) U.S. Cl. CPC H02K 1/2766

(57) ABSTRACT

An electric machine with a rotor having internal permanent magnets. Each rotor pole includes at least one central magnet slot with a permanent magnet disposed therein and first and second outer magnet slots each with a permanent magnet disposed therein. The rotor poles each define a radial centerline. The first and second outer magnet slots are positioned on opposite circumferential sides of the radial centerline and are at least partially positioned radially outwardly of a radially outermost edge of the at least one central magnet slot. The first and second outer magnet slots each define a tapered material bridge disposed between the outer magnet slot and a radially outer perimeter of the rotor core. Each of the tapered material bridges defines a variable radial thickness with the variable radial thickness increasing as the circumferential distance from the radial centerline of the pole increases.

### BACKGROUND

### 1. Technical Field

The present invention relates to electrical machines and, more particularly, to electrical machines utilizing permanent magnets.

### 2. Description of the Related Art

Interior permanent magnet electric machines are often employed in hybrid vehicles due in part to their relatively high torque density and efficiency. Such interior permanent magnet electric machines employ a rotor that includes permanent magnets mounted therein to provide the rotor field.

One issue presented by such interior permanent magnet electric machines is the back electromotive force (BEMF) generated during operation of the machine. This BEMF acts against the torque generated by the electric machine when it is operating as a motor and it is, therefore, desirable to minimize such BEMF. However, design efforts to reduce BEMF may also undesirably reduce the maximum output torque of the electric machine.

While known internal permanent magnet electric machines are effective, further improvements remain desirable.

### SUMMARY

The present invention provides an interior permanent magnet electric machine with a rotor configuration that enhances the performance of the electric machine.

The invention comprises, in one form thereof, an electric machine that includes a stator operably coupled with a rotor. The rotor is rotatable about a rotational axis and includes a rotor core formed out of magnetically permeable material and defines a plurality of poles. Each pole includes a plurality of axially extending magnet slots formed in the rotor core with at least one permanent magnet being positioned in each of the magnet slots. The rotor is configured such that each of the plurality of poles defines a respective radial centerline and for each of the plurality of poles: the plurality of magnet slots includes at least one central magnet slot and first and second outer magnet slots. The first and second outer magnet slots are positioned on opposite circumferential sides of the radial centerline of the pole and are at least partially positioned radially outwardly of a radially outermost edge of the at least one central magnet slot. The first and second outer magnet slots respectively define first and second material bridges disposed between the first and second outer magnet slots and a radially outer perimeter of the rotor core. Each of the first and second material bridges defines a variable radial thickness between the respective first and second magnet slot and the outer radial perimeter of the rotor core with the variable radial thickness of each of the first and second material bridges increasing as the circumferential distance from the radial centerline of the pole increases.

In some embodiments of the electric machine, each of the first and second outer magnet slots are positioned circumferentially outwardly of the at least one central magnet slot.

In some embodiments of the electric machine each of the first and second outer magnet slots defines a gap between a permanent magnet disposed therein and the material bridge, the gap having a radial dimension that becomes greater as the circumferential distance from the radial centerline of the pole increases. In such embodiments, the radial dimension of the gaps may be zero at a circumferentially inner edge of each of the first and second outer magnet slots.

In some embodiments of the electric machine, the permanent magnets are all parallelepipeds wherein each face of the permanent magnets is rectangular.

In some embodiments, the at least one central magnet slot comprises two central magnet slots. In such embodiments, each pole may consist of exactly two central magnet slots and the first and second outer magnet slots with each of the magnet slots has a single permanent magnet disposed therein and wherein each of the permanent magnets is a parallelepiped with each face of the permanent magnets being rectangular. Furthermore, the permanent magnets may be configured such that the permanent magnets disposed in the first and second outer magnet slots have the same dimensions and the permanent magnets disposed in the central magnet slots have the same dimensions with each of the permanent magnets having a common axial length. In such an embodiment, each pole of the rotor may be symmetrical about the radial centerline of the pole with the permanent magnets disposed in the central magnet slots extending a greater circumferential distance than radial distance and the permanent magnets disposed in the first and second outer magnet slots extending a greater radial distance than circumferential distance.

The invention comprises, in another form thereof, an electric machine that includes a stator operably coupled with a rotor with the rotor being rotatable about a rotational axis. The rotor includes a rotor core formed out of magnetically permeable material and defines a plurality of poles. Each pole includes a plurality of axially extending magnet slots formed in the rotor core with at least one permanent magnet being positioned in each of the magnet slots. Each of the plurality of poles defines a respective radial centerline and each of the plurality of poles has a configuration that is symmetrical about the respective radial centerline. For each of the plurality of poles: the plurality of magnet slots includes a pair of central magnet slots with one of the pair of central magnet slots being disposed on each circumferential side of the radial centerline of the pole, and first and second outer magnet slots, the first and second outer magnet slots being disposed on opposite circumferential sides of the radial centerline of the pole and being at least partially positioned circumferentially outwardly of the pair of magnet slots and at least partially positioned radially outwardly of a radially outermost edge of the central magnet slots and wherein the permanent magnets disposed in the pair of central magnet slots extend a greater circumferential distance than radial distance and the permanent magnets disposed in the first and second outer magnet slots extend a greater radial distance than circumferential distance; and wherein the first and second outer magnet slots respectively define first and second material bridges disposed between the first and second outer magnet slots and a radially outer perimeter of the rotor core, wherein each of the first and second material bridges defines a variable radial thickness between the respective first and second magnet slot and the outer radial perimeter of the rotor core, the variable radial thickness of each of the first and second material bridges increasing as the circumferential distance from the radial centerline of the pole increases and wherein each of the first and second outer magnet slots defines a gap between a permanent magnet disposed therein and the material bridge, the gap having a radial dimension that becomes greater as the circumferential distance from the radial centerline of the pole increases.

In some embodiments of the electric machine, the pair of central magnet slots are linearly aligned and the first and second outer magnet slots are separated by a circumferential distance that becomes greater as the first and second outer magnet slots approach the outer radial perimeter of the rotor core.

In some embodiments, the electric machine is still further configured such that each of the central magnet slots has a permanent magnet disposed therein which is positioned directly adjacent an inner circumferential edge of the respective central magnet slot.

In some embodiments, the electric machine is still further configured such that each of the central magnet slots defines a gap between the permanent magnet disposed therein and an outer circumferential edge of each respective central magnet slot and wherein each of the first and second outer magnet has a permanent magnet disposed therein which is positioned to define a gap between the respective permanent magnets and an inner radial edge of each of the first and second outer magnet slots.

In some embodiments, the electric machine is still further configured such that each pole consists of exactly two central magnet slots and the first and second outer magnet slots and each of the magnet slots has a single permanent magnet disposed therein, each of the permanent magnets being parallelepipeds wherein each face of the permanent magnets is rectangular and wherein the permanent magnets disposed in the first and second outer magnet slots have the same dimensions and the permanent magnets disposed in the central magnet slots have the same dimensions with each of the permanent magnets having a common axial length.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a schematic cross-sectional view of an electric machine.

FIG. 2 is a partial end view of a rotor.

FIG. 3 is a partial end view of a rotor showing a single pole.

FIG. 4 is a partial end view of a rotor showing a detail view of a portion of a single pole having a tapered material bridge.

FIG. 5 is a partial end view of a rotor showing a detail view of a portion of a single pole having a non-tapered material bridge.

FIG. 6 is a partial end view of the rotor of FIG. 5 depicting flux density at no load.

FIG. 7 is a partial end view of the rotor of FIGS. 1-4 depicting flux density at no load.

FIG. 8 is a chart comparing the air-gap flux density for the rotor pole flux densities shown in FIGS. 6 and 7.

FIG. 9 is a chart comparing the BEMF for electric machines having the operating conditions depicted in FIGS. 6 and 7.

FIG. 10 is a partial end view of the rotor depicted in FIG. 5 depicting flux density at full load.

FIG. 11 is a partial end view of the rotor of FIGS. 1-4 depicting flux density at full load.

FIG. 12 is a chart comparing the air-gap flux density for the rotor pole flux densities shown in FIGS. 10 and 11.

Corresponding reference characters indicate corresponding parts throughout the several views. Although the exemplification set out herein illustrates embodiments of the invention, in one form, the embodiment disclosed below is not intended to be exhaustive or to be construed as limiting the scope of the invention to the precise forms disclosed.

### DETAILED DESCRIPTION

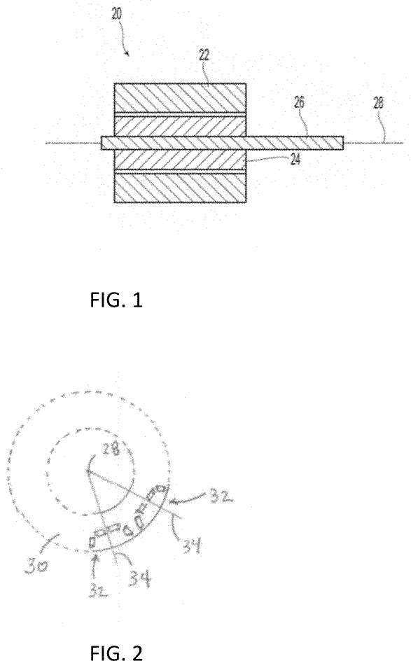

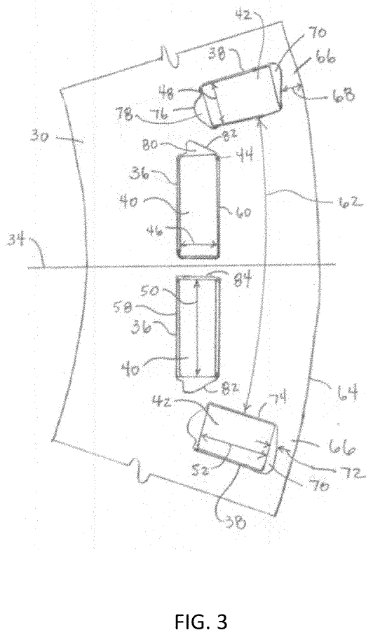

FIG. 1 provides a schematic cross-sectional view of an electric machine 20. Electric machine 20 includes a stator 22 having a stator core and a plurality of windings. A rotor 24 is operably coupled with stator 22 and has a shaft 26 secured thereto. Rotor 24 and shaft 26 rotate relative to stator 22 about rotational axis 28. Electric machine 20 is an interior permanent magnet synchronous machine (IPMSM) and may be employed as a motor/generator in a hybrid vehicle wherein it selectively operates as either a motor or a generator.

Rotor 24 includes a rotor core 30 and defines a plurality of magnetic poles 32 which interact with stator 22 during operation of electric machine 20. The illustrated electric machine 20 is an internal permanent magnet electric machine and each of the poles 32 of rotor 24 include a plurality of axially extending magnet slots formed in rotor core 30 with at least one permanent magnet positioned in each of the magnet slots. The magnets may be secured within the slots using an interference fit, using an adhesive material, another securement method or combination of securement methods.

Rotor core 30 is formed out of magnetically permeable material. For example, rotor core 30 may be formed out of a plurality of stacked laminations wherein each individual lamination is a sheet of electrical steel. The use of stacked electrical steel laminations to form a rotor core is well known to those having ordinary skill in the art. Electrical steel often has a relative magnetic permeability of around 4,000. By definition, a vacuum has a relative magnetic permeability of 1.

As discussed in greater detail below, the magnet slots formed in rotor core 30 define gaps at selected locations in each pole 32. These gaps have a relative magnetic permeability less than that of the rotor core 30. For example, these gaps may be filled with air. Air has a relative magnetic permeability of 1.00000037. Which, for purposes of this disclosure can be rounded to the nearest whole number, i.e., 1. Instead of leaving the gaps as air-filled voids, it is also possible to fill these gaps with a polymeric and/or adhesive material which may be used to further secure the magnets within the slots. Advantageously, the material used to fill the gaps has a relative magnetic permeability of 1.

Each of the rotor poles 32 define a radial centerline 34 that intersects rotational axis 28. In the illustrated embodiment, poles 32 are symmetric about centerline 34, however, alternative embodiments could include some asymmetric features. In this regard, it is noted that the illustrated electric machine is operable in both rotational directions, however, alternative embodiments could be used for applications where the electric machine operates in only one rotational direction. The illustrated embodiment includes ten rotor poles 32, however, alternative embodiments may employ a different number of poles.

The individual poles 32 have include at least one central magnet slot 36 and two outer magnet slots 38. In the illustrated embodiment, each of the poles 32 have the same configuration and include two central magnet slots 36 with one of the central magnet slots 36 being disposed on each side of the radial centerline 34. Outer magnet slots 38 are positioned on opposite circumferential sides of radial centerline 34 and, advantageously, at least partially circumferentially outwardly of a radially outermost edge 44 of the central magnet slots 36. In the illustrated embodiment, the permanent magnets 42 within outer magnet slots 38 are positioned entirely circumferentially outwardly of the permanent magnets 40 disposed within central magnet slots 36.

Each of the slots 36, 38 has at least one permanent magnet 40, 42 disposed therein. In the illustrated embodiment, each slot 36, 38 has only a single magnet 40, 42 disposed therein, however, alternative embodiments could position more than one magnet in one or more of the magnet slots.

As can be seen in the figures, magnets 42 disposed in the outer magnet slots 38 are smaller than the magnets 40 disposed in the central magnet slots 36. All of the magnets 42 disposed in the outer magnet slots 38 have the same dimensions and all of the magnets 40 disposed in the central magnet slots 36 have the same dimensions.

In the illustrated embodiment, permanent magnets 40, 42 are all parallelepipeds with each face of the permanent magnets 40, 42 being rectangular. In this regard, it is noted that the faces are not perfectly rectangular but have slightly rounded corners and edges.

All of the magnets 40, 42 have the same axial length. Magnets 40 disposed in central magnet slots 36 have a greater length 50 and smaller width 46 than the length 52 and width 48 of magnets 42 disposed in outer magnet slots 38.

The use of a rectangular cross section and common axial length provides for manufacturing efficiency. The axial length of the magnets corresponds to the axial length of the rotor core 30. The illustrated magnets are all formed out of the same material. Any suitable permanent magnetic material may be used. For example, magnets 40, 42 may take the form of rare earth magnets or ferrite magnets.

It is additionally noted that while the illustrated embodiment has a single magnet disposed in each slot and uses two differently sized magnets, under some circumstances it may prove more efficient to utilize multiple magnets in some or all of the magnet slots. For example, it might be possible to use only one sized magnet and employ three of the magnets in the central slots and two of the magnets in the outer slots if electric machine 20 were designed with all of the magnets having a common width.

Magnet slots 36, 38 of each pole 32 are positioned to define a U-shaped configuration with magnets 40 positioned in central slots 36 oriented such that they extend a greater circumferential distance than radial distance. In this regard, it is noted that magnets 40 are positioned such that length 50 is substantially equivalent to the circumferential distance over which magnets 40 extend and width 46 is substantially equivalent to the radial distance over which magnets 40 extend. Magnets 42 positioned in outer magnet slots 38 are oriented such that they extend a greater radial distance, which generally corresponds to length 52, than circumferential distance, which generally corresponds to width 48.

In the illustrated embodiments, central magnet slots 36 are linearly aligned with the radially inner edges 58 of both slots be colinear and the radially outer edges 60 also being colinear. Outer magnet slots 38 are separated by a circumferential distance 62 that becomes greater as the outer magnet slots 38 approach the outer radial perimeter 64 of rotor core 30. In other words, outer magnet slots 38 angle outwardly as they progress radially outwardly.

Outer magnet slots 38 each define a material bridge 66 that is disposed between the outer magnet slot 38 and the radially outer perimeter 64 of rotor core 30. Material bridges 66 are tapered bridges that define a radial thickness 68 that varies. As can be seen in the figures, material bridges 66 have a radial thickness 68 that increases as the circumferential distance from the radial centerline 34 increases.

In each outer magnet slot 38, a gap 70 is defined between permanent magnet 42 and material bridge 66. Gap 70 defines a radial dimension 72 that becomes greater as the circumferential distance from radial centerline 34 increases. In the illustrated embodiment, gap 70 disappears, i.e., has a radial dimension of zero, at the circumferentially inner edge 74 of slot 38.

Each of the poles 32 is configured to define two additional gaps in the magnet slots. At the radially inner edge 76 of outer magnet slots 38, magnet 42 is positioned to define a gap 78 between magnet 42 and radially inner edge 76. In the central magnet slots 36, a gap 80 is formed between the permanent magnet 40 and the outer circumferential edge 82 of the central magnet slot 36. Permanent magnet 40 is positioned directly adjacent the inner circumferential edge 84 of the central magnet slot 36 whereby no gap is formed at this edge. In this regard, it is noted that a thin layer of adhesive or other material may be present between magnet 40 and inner circumferential edge 84. Additionally, or alternatively, small voids due to manufacturing tolerances may be present between magnet 40 and inner circumferential edge 84 without thereby defining a gap within central magnet slot 36 which would materially impact the electromagnetic flux at this location during operation in the manner of gaps 70, 78, 80. As mentioned above, gaps 70, 78, 80 may be air-filled voids or may be filled with a polymeric and/or adhesive material which may be used to secure the magnets within the slots. If the gaps are filled with a solid material, it will generally be desirable to use a material having a relative magnetic permeability of 1.

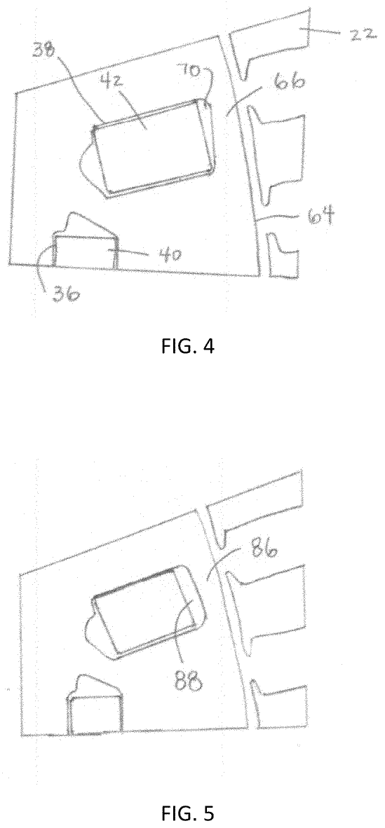

FIG. 4 provides a detail view of tapered material bridge 66. The use of a tapered bridge 66 provides certain advantages over a material bridge 86 which is not tapered as depicted in FIG. 5. Material bridge 86 has a radial thickness that remains substantially constant and defines a gap 88 within the magnet slot that also has a radial dimension that remains substantially constant. The only variation in the radial dimension of bridge 86 and gap 88 is due to either the curvature of the outer perimeter of the rotor core or the rounded nature of the interior corners of the magnet slot. In contrast, and as discussed above, material bridge 66 has a radial thickness that varies. Bridge 86 is also be referred to as a parallel bridge herein because the two edges of the bridge are substantially parallel with each other.

Changing the shape of the material bridge from a parallel bridge 86 having a consistent radial thickness to a tapered bridge 66 affects several properties of electric machine 20. By providing a thinner bridge, the leakage flux can be reduced which increases the output torque of a motor. However, reducing the radial thickness of this material bridge, while keeping it at a constant radial thickness, reduces the mechanical strength of this bridge, which is necessary to retain the magnet within the adjacent magnet slot and also increases the back electromotive force (BEMF) experienced by the electric machine. Thus, for electric machines having a parallel bridge 86 with a consistent radial thickness, all else remaining constant, a thinner bridge provides a higher output torque and a higher BEMF and a reduced structural capacity for holding magnets compared to a thicker bridge.

Using a tapered bridge, e.g., material bridge 66, provides much of the advantages associated with a thinner bridge while minimizing the disadvantages. More specifically, tapered bridge 66 functions similar to a thicker bridge when under minimal or no load, thereby generating reduced BEMF similar to a thicker parallel bridge, due to lower magnetic saturation of the rotor core. When operating at or near full load, tapered bridge 66 functions more similar to a thinner parallel bridge, thereby providing an enhanced peak output torque, due to full magnetic saturation. The configuration of the tapered bridge also functions as an advantageous compromise with regard to structural strength.

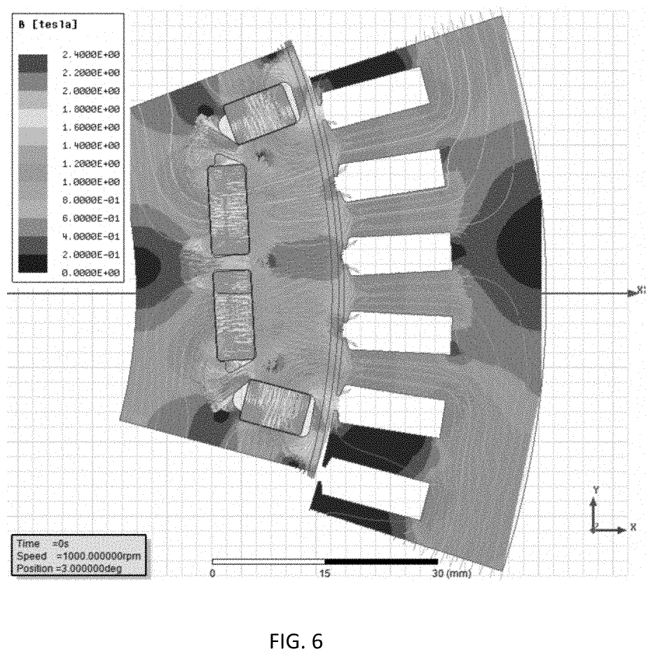

A computer model was used to compare an electric machine having a parallel bridge 86 with an electric machine having a tapered bridge 66 while keeping all other features of the electric machine similar. FIGS. 6-12 provide the results of this computer modelling.

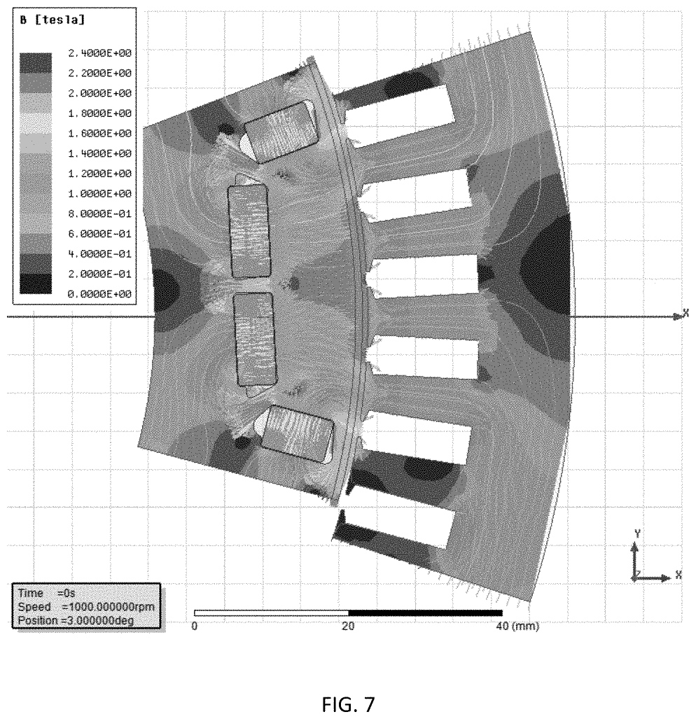

FIG. 6 shows the calculated flux density of a rotor pole of an electric machine having parallel bridges at no load and the adjacent portion of the stator core (the stator windings are not shown). Similarly, FIG. 7 shows the calculated flux density of a rotor pole of electric machine 20 having tapered bridges 66 and the adjacent portion of the stator core at no load.

In both FIGS. 6 and 7, the electric machine is being operated as a motor and the rotor is rotating at 1000 rpm in a direction counterclockwise as viewed in FIGS. 6 and 7. The calculated strength of the magnetic field B (measured in tesla) within the electric machine is represented by different colors in FIGS. 6 and 7. As shown in the legend, the different colors represent values between 2.4 tesla down to zero tesla in 2.0×10⁻¹ tesla increments.

As can be seen from a comparison of FIGS. 6 and 7, there is a lower magnetic saturation in the rotor core at the tapered material bridge 66 compared to the parallel bridge 86 which corresponds to more flux leakage at tapered material bridge 66. As can also be seen by a comparison of FIGS. 6 and 7, the value magnetic field at the air gap between the rotor and stator is lower in FIG. 7 not only adjacent tapered bridge 66 but also between the two bridges compared to the value of the magnetic field in FIG. 6. This results in a lower BEMF for the electric machine of FIG. 7 compared to the electric machine of FIG. 6.

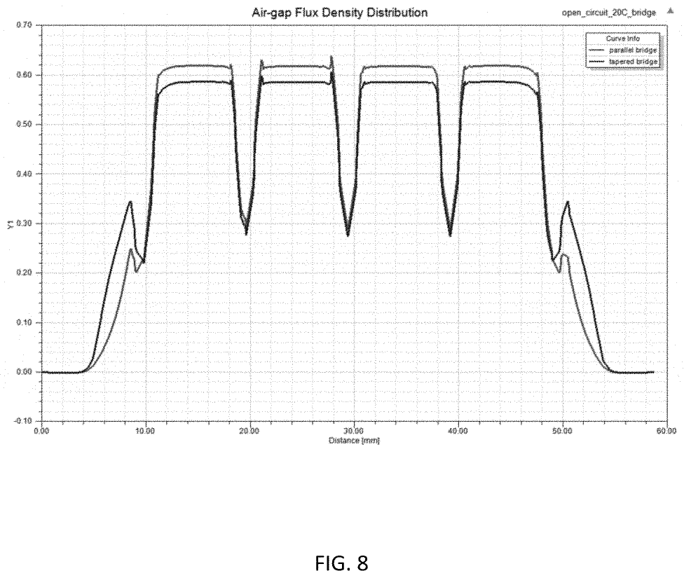

The chart of FIG. 8 compares the flux density, for a single rotor pole, in the air-gap between the rotor and stator for the electric machine of FIG. 6 (red line) to the flux density in the air-gap between the rotor and stator for the electric machine of FIG. 7 (blue line). As can be seen in this chart, except for the very outer circumferential limits of the pole, the flux density is lower for the electric machine having a tapered bridge 66 when operating as a motor under no load.

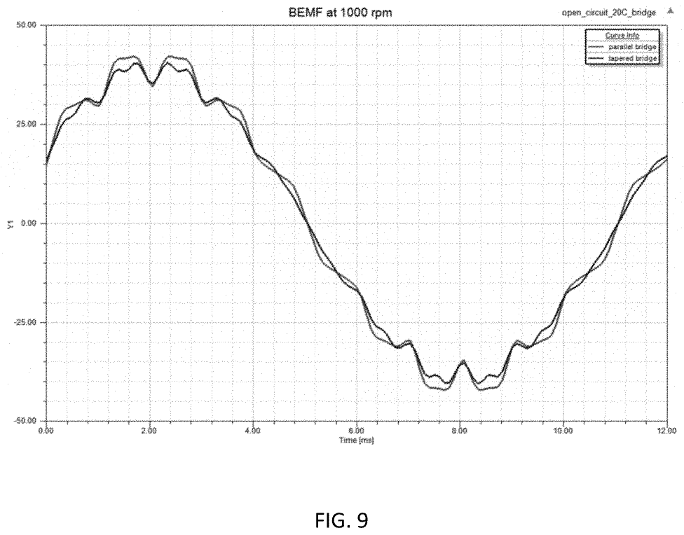

The chart in FIG. 9 compares the BEMF for the electric machine of FIG. 6 with the electric machine of FIG. 7 when operating as a motor under no load over a period of time. As can be seen from this chart, the BEMF is approximately 5% less for the electric machine having a tapered bridge. This reduction in BEMF is desirable and beneficial.

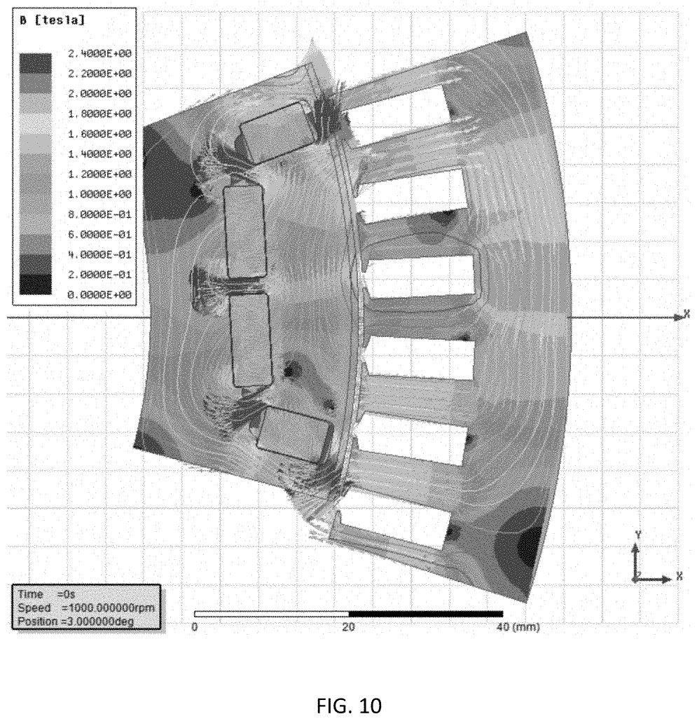

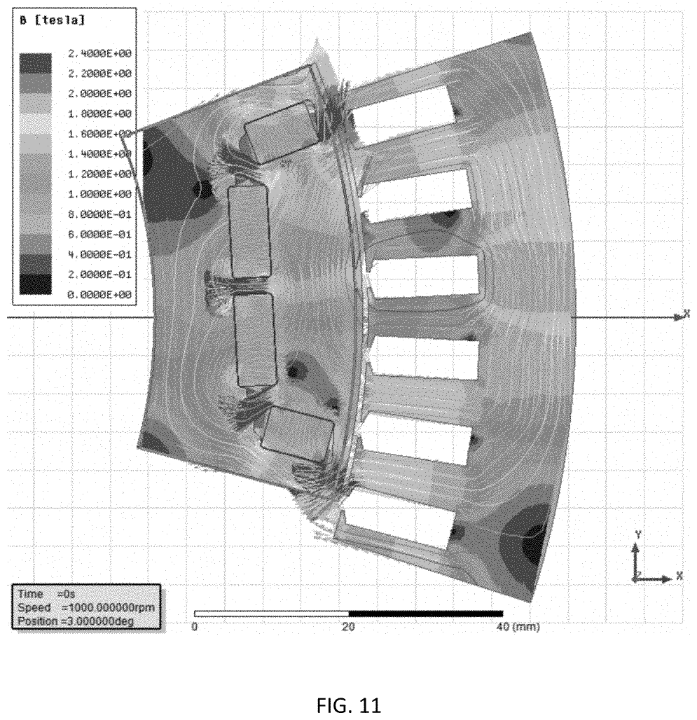

FIG. 10 shows the calculated flux density of a rotor pole of an electric machine having parallel bridges at full load and the adjacent portion of the stator core (the stator windings are not shown). Similarly, FIG. 11 shows the calculated flux density of a rotor pole of electric machine 20 having tapered bridges 66 and the adjacent portion of the stator core at full load.

In both FIGS. 10 and 11, the electric machine is being operated as a motor and the rotor is rotating at 1000 rpm in a direction counterclockwise as viewed in FIGS. 10 and 11. The calculated strength of the magnetic field B (measured in tesla) within the electric machine is represented by different colors in FIGS. 10 and 11. As shown in the legend, the different colors represent values between 2.4 tesla down to zero tesla in 2.0×10⁻¹ tesla increments.

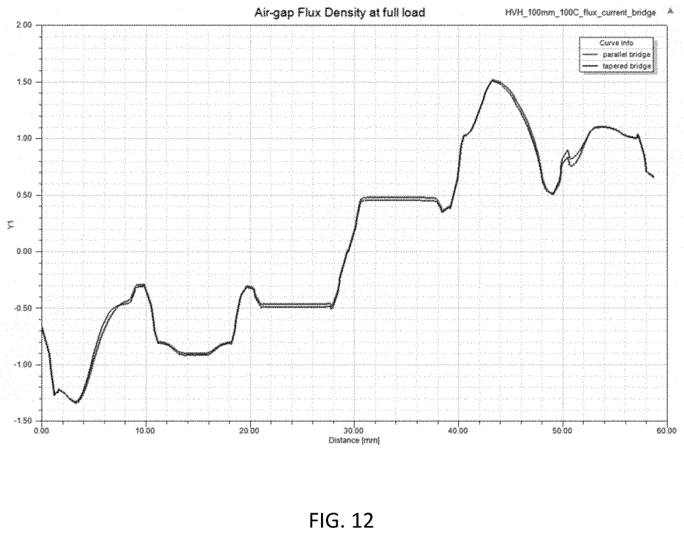

As can be seen in FIGS. 10 and 11, the magnetic field is nearly identical at full load for the two electric machines depicted in FIGS. 10 and 11. FIG. 12 presents a chart that compares the flux density, for a single rotor pole, in the air-gap between the rotor and stator for the electric machine of FIG. 10 (red line) to the flux density in the air-gap between the rotor and stator for the electric machine of FIG. 11 (blue line). As can be seen in this chart, the flux density when the electric machines are operating as a motor at full load is very similar for the electric machines of FIGS. 11 and 12. These results indicate that the electric machine having tapered bridges 66 would have an output torque that is approximately 0.3% less than the output torque of the electric machine having parallel bridges 86. Thus, the use of an electric machine with tapered bridges 66 could satisfy the same output torque requirement as the electric machine with parallel bridges 86 and have a BEMF of roughly 5% less when operating at no load.

While this invention has been described as having an exemplary design, the present invention may be further modified within the spirit and scope of this disclosure. This application is therefore intended to cover any variations, uses, or adaptations of the invention using its general principles.

What is claimed is:

1. An electric machine comprising:
a stator operably coupled with a rotor, the rotor being rotatable about a rotational axis; wherein the rotor includes a rotor core formed out of magnetically permeable material, the rotor defining a plurality of poles, wherein each pole includes a plurality of axially extending magnet slots formed in the rotor core with at least one permanent magnet being positioned in each of the magnet slots; and
wherein each of the plurality of poles defines a respective radial centerline; and
for each of the plurality of poles:
the plurality of magnet slots includes at least one central magnet slot and first and second outer magnet slots, the first and second outer magnet slots being positioned on opposite circumferential sides of the radial centerline of the pole and being at least partially positioned radially outwardly of a radially outermost edge of the at least one central magnet slot; and
wherein the first and second outer magnet slots respectively define first and second material bridges disposed between the first and second outer magnet slots and a radially outer perimeter of the rotor core, wherein each of the first and second material bridges defines a variable radial thickness between the respective first and second magnet slot and the outer radial perimeter of the rotor core, the variable radial thickness of each of the first and second material bridges increasing as the circumferential distance from the radial centerline of the pole increases.

2. The electric machine of claim 1 wherein each of the first and second outer magnet slots are positioned circumferentially outwardly of the at least one central magnet slot.

3. The electric machine of claim 1 wherein each of the first and second outer magnet slots defines a gap between a permanent magnet disposed therein and the material bridge, the gap having a radial dimension that becomes greater as the circumferential distance from the radial centerline of the pole increases.

4. The electric machine of claim 3 wherein the radial dimension of the gaps is zero at a circumferentially inner edge of each of the first and second outer magnet slots.

5. The electric machine of claim 1 wherein the permanent magnets are all parallelepipeds wherein each face of the permanent magnets is rectangular.

6. The electric machine of claim 1 wherein the at least one central magnet slot comprises two central magnet slots.

7. The electric machine of claim 6 wherein each pole consists of two central magnet slots and the first and second outer magnet slots and each of the magnet slots has a single permanent magnet disposed therein, each of the permanent magnets being parallelepipeds wherein each face of the permanent magnets is rectangular and wherein the permanent magnets disposed in the first and second outer magnet slots have the same dimensions and the permanent magnets disposed in the central magnet slots have the same dimensions with each of the permanent magnets having a common axial length.

8. The electric machine of claim 7 wherein each pole is symmetrical about the radial centerline of the pole and wherein the permanent magnets disposed in the central magnet slots extend a greater circumferential distance than radial distance and the permanent magnets disposed in the first and second outer magnet slots extend a greater radial distance than circumferential distance.

9. An electric machine comprising:
a stator operably coupled with a rotor, the rotor being rotatable about a rotational axis; wherein the rotor includes a rotor core formed out of magnetically permeable material, the rotor defining a plurality of poles, wherein each pole includes a plurality of axially extending magnet slots formed in the rotor core with at least one permanent magnet being positioned in each of the magnet slots; and
wherein each of the plurality of poles defines a respective radial centerline with each of the plurality of poles having a configuration that is symmetrical about the respective radial centerline; and
for each of the plurality of poles:
the plurality of magnet slots includes a pair of central magnet slots with one of the pair of central magnet slots being disposed on each circumferential side of the radial centerline of the pole, and first and second outer magnet slots, the first and second outer magnet slots being disposed on opposite circumferential sides of the radial centerline of the pole and being at least partially positioned circumferentially outwardly of the pair of magnet slots and at least partially positioned radially outwardly of a radially outermost edge of the central magnet slots and wherein the permanent magnets disposed in the pair of central magnet slots extend a greater circumferential distance than radial distance and the permanent magnets disposed in the first and second outer magnet slots extend a greater radial distance than circumferential distance; and
wherein the first and second outer magnet slots respectively define first and second material bridges disposed between the first and second outer magnet slots and a radially outer perimeter of the rotor core, wherein each of the first and second material bridges defines a variable radial thickness between the respective first and second magnet slot and the outer radial perimeter of the rotor core, the variable radial thickness of each of the first and second material bridges increasing as the circumferential distance from the radial centerline of the pole increases and wherein each of the first and second outer magnet slots defines a gap between a permanent magnet disposed therein and the material bridge, the gap having a radial dimension that becomes greater as the circumferential distance from the radial centerline of the pole increases.

10. The electric machine of claim 9 wherein the pair of central magnet slots are linearly aligned and wherein the first and second outer magnet slots are separated by a circumferential distance that becomes greater as the first and second outer magnet slots approach the outer radial perimeter of the rotor core.

11. The electric machine of claim 10 wherein the permanent magnet disposed in each respective central magnet slot is positioned directly adjacent an inner circumferential edge of the respective central magnet slot.

12. The electric machine of claim 11 wherein each of the central magnet slots defines a gap between the permanent magnet disposed therein and an outer circumferential edge of each respective central magnet slot and wherein each of the first and second outer magnet has a permanent magnet disposed therein which are positioned to define a gap between the respective permanent magnets and an inner radial edge of each of the first and second outer magnet slots.

13. The electric machine of claim 12 wherein each pole consists of two central magnet slots and the first and second outer magnet slots and each of the magnet slots has a single permanent magnet disposed therein, each of the permanent magnets being parallelepipeds wherein each face of the permanent magnets is rectangular and wherein the permanent magnets disposed in the first and second outer magnet slots have the same dimensions and the permanent magnets disposed in the central magnet slots have the same dimensions with each of the permanent magnets having a common axial length.
